(19) United States
(12) Patent Application Publication
(10) Pub. No.: US 2013/0101707 A1
(43) Pub. Date: Apr. 25, 2013

(54) CONSUMABLES AND METHODS OF PRODUCTION THEREOF

(71) Applicants: Peter Clarke, Berkshire (GB); Clive Richard Thomas Norton, Chatham, NJ (US); Sarah Marshall, West Berkshire (GB); Simon Bradbury, Middlesex (GB)

(72) Inventors: Peter Clarke, Berkshire (GB); Clive Richard Thomas Norton, Chatham, NJ (US); Sarah Marshall, West Berkshire (GB); Simon Bradbury, Middlesex (GB)

(21) Appl. No.: 13/583,391

(22) PCT Filed: Mar. 23, 2011
(86) PCT No.: PCT/GB11/50590

§ 371 Date: Nov. 15, 2012

(30) Foreign Application Priority Data
Mar. 23, 2010 (GB) 1004897.3
Mar. 23, 2010 (US) 61316464

(51) Int. Cl. A23G 3/54

(52) U.S. Cl. CPC A23G 3/545
USPC 426/103; 426/514; 426/302

(57) ABSTRACT

The present invention relates to a confectionery product comprising an extruded body portion and at least one extruded tubule, wherein the tubule comprises a tube or a flfst material and a bore of a second material, and the tube is formed of a different material than that of the body portion and/or the bore. The invention also relates to a method of production of the same.

### TECHNICAL FIELD OF THE INVENTION

The present invention relates to novel consumable products and also to a method of production thereof. In particular, the invention relates to confectionery products comprising at least one tubule.

### BACKGROUND TO THE INVENTION

It is desirable to produce consumable products (i.e. edible items such as foodstuffs, toothpaste, etc) formed of different components, so as to increase sensory pleasure. A number of consumable products exist, which have a flavoured liquid or syrup centre which is released upon chewing. For example, WO 2007/056685 discloses an apparatus and method for the continuous production of centre-filled confectionery products in the format of a continuous extrudate having a plurality of centre-filled confectionery ropes. Whilst a product formed from such an apparatus does increase sensory pleasure, the period of pleasure is often short lived as the centre is released too quickly and/or degraded. It is therefore an object of the present invention to provide a consumable product which can release a centre-fill over an extended period of time.

There is also a demand for providing consumable products having a reduced fat or sugar content. It is thus an object of the present invention to provide a consumable product which can be produced having a lowered fat or sugar content, whilst still maintaining an excellent sensory pleasure.

Further, there is demand for consumable products having improved visual appearance whilst maintaining flavour. It is thus a further object of the present invention to provide a consumable product which is eye-catching whilst still providing a desirable flavour.

Yet further there is demand for consumable products having improved convenience whilst maintaining or improving flavour. It is thus a further object of the invention to provide a consumable product which increases convenience whilst still maintaining, or even improving, flavour.

It would be beneficial to be able to include two or more components into a consumable product which are generally immiscible or incompatible with one another.

It is another object of the invention to provide a consumable product having an improved or novel sensory experience.

### SUMMARY OF THE INVENTION

According to an embodiment, there is provided a confectionery product comprising an extruded body portion and at least an extruded tubule, wherein the tubule comprises a tube of a first material and a bore of a second material, and the tubule is formed of a different material than that of the body portion and/or the bore.

The confectionery product of the present invention has an extended release of any material inserted into the tubules, and/or may include a large voidage so as to reduce the amount of material used in the product, whilst maintaining the overall size of the product. Further, the consumable product has a more diverse cross section such that it is more eye-catching, and with the convenience of any material inserted into the tubules being integral with the consumable product and leakage from the ends of the product minimised.

Furthermore, the confectionery product of the present invention also advantageously allows for immiscible or incompatible components to be included into the product. For example, volatile components can be included within the tubules and then kept away from reactive components in the body portion.

It should be understood that the term “tubule” generally refers to a conduit or space created by an extrusion or other forming process within the body of the product. The tubule typically contains matter, and that matter can be in the form of a gas, a liquid, a solid, or a mixture thereof.

It should be understood that the term “voidage” generally refers to the volume percent of the tubule volume relative to the sum of the tubule volume and the extruded body portion volume. That is voidage (%)=100×tubule volume/(tubule volume+extruded body portion volume). In some embodiments, the extruded body portion volume does not include any central region volume created by certain dies, such as an annular die.

In some embodiments, the body portion is a confectionery, for example chocolate. Suitable chocolate includes dark, milk, white and compound chocolate. In some embodiments, the confectionery is chewing gum, bubble gum or gum base. In other embodiments, the confectionery is candy. Suitable candy includes hard candy, chewy candy, gummy candy, jelly candy, toffee, fudge, nougat and the like.

The tubule(s) may be located within the body portion, for example running along a longitudinal axis (that is to say, running in the direction of extrusion) of the body portion. In this instance the tubule(s) are typically extruded during extrusion of the extruded body portion. In another option the tubule(s) can be present on the exterior of the body portion, for example running along the longitudinal axis of the body portion or in any other orientation e.g. random, perpendicular or at an inclined angle to the longitudinal axis. Gaps can exist between tubules present on the exterior of the body portion, or the tubules can be touching one another.

In a yet further option, the body portion is comprised of two or more sections, for example two solid slabs, where the tubules are sandwiched between the two slabs.

In another further option, multiple tubules are held together by a body portion located within the gaps formed between adjacent tubules.

The tubules may extend along substantially the entire length of the body portion, but may in some embodiments extend no less than 75%, 80%, 90%, 95% or 99% along the length of the body portion. If the tubules extend along the entire length of body portion, typically the ends of the tubules are visible at one or more ends of the body portion. The cross-section of the tubule may be circular or polygonal or if a plurality of tubules are provided—a mixture of both circular and polygonal shapes.

It should be understood that the term “plurality” is intended to mean two or more. In some embodiments, a plurality is 3 or more, or 4 or more, or 5 or more, or 6 or more, or 7 or more. There is no particular upper limit on the number associated with “plurality”. In the context of the phrase “plurality of tubules”, numbers up to 50 and higher are contemplated.

The tubule is formed of a first material, wherein this first substance may comprise a number of materials commonly used in the production of confectionery (e.g. candy, gum and chocolate, caramel, cocoa butter, fondant, syrups, peanut butter, jam, jelly, gels, emulsions, truffles, custard cream, etc).

Suitable chocolate includes dark, milk, white and compound chocolate. In some embodiments, the confectionery is chewing gum, bubble gum or gum base or constituents thereof. In other embodiments, the confectionery is candy. Suitable candy includes hard candy, chewy candy, gummy candy, jelly candy, toffee, fudge, nougat and the like.

The bore part of the tubule may be formed of a second substance, wherein this second substance may comprise a number of materials commonly used in the production of consumable products—for example foodstuffs such as confectionery (e.g. candy, gum and chocolate, caramel, cocoa butter, fondant, syrups, peanut butter, jam, jelly, gels, truffle, custard cream, etc). The first and second substances may be different to one another in some way, for example in composition, viscosity, concentration, etc.

The tube is formed of a different material than that of the body portion and/or the bore. It should be understood that the term “different” is intended to mean differs in some way, or by some characteristic of the material, i.e. not-identical. This can be any characteristic of the material, such as composition, viscosity, concentration, colour, texture, physical form, etc. For example, a material being a yellow coloured candy is considered as different to a material being a green coloured candy, etc. Similarly, a material being a candy is different to a material being a gum, chocolate, caramel, cocoa butter, etc.

Advantageously, materials which would have otherwise been immiscible or incompatible with the material of the body portion, can be safely incorporated into the bore and the tubule acts as a “barrier” in order to prevent mixing or migration of the two materials. For example, it may be desired to separate a volatile compound (such as a cooling agent commonly used in confectionery) in the bore material and the tubule acts as a barrier so that migration of the cooling agent into the body portion does not occur. Migration of moisture from liquid centres is often a problem in confectionery products, but again the use of tubules to separate a liquid material from that of the body portion, ensures that no migration of moisture takes place and both components of the confectionery product are only mixed when a consumer chews the product.

The provision of tubules in a confectionery product also provides a novel sensory experience. For example, the body portion may be formed of a relatively soft material, whereas the material used for the tubule may be relatively hard and contains a liquid bore, so that when the product is consumed, the soft body portion has little resistance to chewing, whereas the tubules will be relatively “crispy” and once broken, the liquid bore will be released.

The bore of one or more of the tubule(s) may be filled with a material which is different from that of the material used to form the body portion, i.e. the second substance (comprised within the tubule bore) may be different to the substance used to make the body portion. Alternatively the bore may comprise the same substance as the body portion. Different tubules may incorporate different materials if desired, and/or any one tube or bore can be filled with different substances along its length. The tube(s) and/or bore(s) may comprise a fluid material. Such a fluid may comprise a liquid. The tube(s) and/or bore(s) may be filled with a material which is solid at a room temperature and fluid at a temperature greater than room temperature. For example, a molten chocolate may be incorporated into the tube(s) and/or bore(s) and allowed to set when cooled to room temperature. It will be apparent to the skilled addressee that room temperature is commonly regarded as around 20° C. Alternatively, the tube(s) and/or bore(s) may be filled with a material which is deposited as a liquid and which subsequently solidifies. In such embodiments, the solidification may be dependent or independent of heat. It will be apparent that solidification of a liquid tube and/or bore may be achieved in a number of ways. For example solidification may take place due to one or more of the following:
Cooling—the substance may be molten when deposited which then cools to a solid at room temperature;
Heating—the substance may be liquid when deposited, and the heat of the extruded body portion sets the filling (e.g. pumping egg albumen into a hot hard candy extruded body portion will set the egg on contact);
Drying—the substance may be a solution that dries into a solid (e.g. the moisture from the solution is absorbed into the extruded body portion);
Solvent loss—the substance may be in a solvent, whereby the solvent is absorbed into the extruded body portion, leaving a solid;
Chemical reaction—the substance may be deposited as a liquid but reacts or “goes off” into a solid;
Cross-linking—the substance may form a constituents for a cross-linked material due to mixing and/or heating; and
Time—the substance may simply set with time (e.g. a solution of sugars and gelatin will eventually set over time).

The bore need not be filled with a fill material and may simply form a void filled with air or inert gas. Thus a consumable product may be formed having a large exterior dimensions, but a substantially reduced density which provides good sensory properties.

If desired, the product may further comprise a coating portion to envelop or enrobe the body portion. The skilled addressee will appreciate that a number of coatings could be employed for example chocolate, gum, candy and sugar etc.

In some embodiments, multiple tubules are distributed substantially uniformly throughout the body portion, and may be spaced evenly apart from adjacent tubules. In other embodiments, tubules may be distributed in pre-defined configurations within the body portion, such as around the periphery of the body portion, or in groups at one or more locations within the body. In some embodiments the body portion has a circular, elliptical, regular polygonal or semi-circular cross-section. The body portion may be shaped in the form of a cylinder, a rope, a filament, a strip, a ribbon or the like, or may be shaped in the form of a standard consumable product such a chocolate bar, or chewing gum slab, pellet, ball, stick or ribbon, for example. The exterior of the body portion may be irregular or regular in shape. Furthermore, the body portion may be formed in potentially any shape, for example in the shape of an object, cartoon character or an animal to name a few.

In some embodiments, the tubules have a diameter or width of no more than about 2 mm, 1 mm, 0.5 mm, 0.25 mm, or even less. It is possible to have tubules having a diameter or width of no more than about 100 μm, 50 μm or 10 μm.

According to a further embodiment, there is provided a method of manufacturing a confectionery product, the process comprising the steps of:
a) extruding a body portion, and
b) extruding at least one extruded tubule wherein the tubule comprises a tube of a first material and a bore of a second material, and the tubule is formed of a different material than that of the body portion and/or the bore.

The at least one tubule may be extruded within the body portion. Alternatively, the at least one tubule may be extruded alongside the body portion and the tubule then urged against the body portion so as to form a single confectionery product having two discrete components.

It will be apparent to the skilled addressee that a number of additional processing steps may be employed after the confectionery product has been extruded. For example, the method may further comprise cutting and optionally coating the product. Such a coating may be a chocolate or sugar coating.

The method may also be used in order to produce a confectionery product as hereinabove described.

These steps can be concurrent or sequential (in any order), and can be performed on the same or different machines.

In some embodiments, the process may include an extra step selected from:
b) cutting the body portion and/or the tubule into two or more pieces forming a consumable product incorporating the pieces; and/or
c) folding the body portion and/or the tubule and forming a consumable product incorporating the folded body portion and/or tubule.

Any of the above processes may further comprise the step of depositing a filling in the bore of the tubule. The deposition of the filling may be during the step of extrusion—but could also take place after extrusion. In an embodiment, the filling comprises a fluid. The fluid may comprises a liquid, or a material which is liquid at a temperature greater than room temperature. The fluid may solidify after deposition if desired.

Any of the processes may further comprise the step of quench cooling the body portion and/or tubule after extrusion. The quench cooling may utilise a fluid, such as air, an oil or liquid nitrogen—but other methods of quench cooling will also be apparent to the skilled addressee.

Any of the processes may further comprise the step of, immediately after extrusion, stretching or rotating the body portion and/or the tubule. Stretching or rotating may be undertaken by a number of means, for example passing the body portion over, or through conveyor belts or rollers operating at different speeds, so as to cause stretching.

Any of the processes may further comprise the step of enveloping the consumable product in a coating. Such a coating will be apparent to the skilled addressee and was discussed previously hereinabove.

The extrudable consumable material will at least partially or substantially solidify after extrusion.

As mentioned above, the invention also provides apparatus which is adapted for producing a consumable product according to the processes as herein above described. WO 2005/056272 discloses an apparatus for producing an extrudated product including a plurality of capillary channels. WO 2008/044122 discloses a related apparatus, which additionally includes means for quench cooling an extrudate as it exits the die. Both of these apparatus may be employed/adapted for use in producing the consumable product in accordance with the present invention.

### DETAILED DESCRIPTION OF THE INVENTION AND EXAMPLES

Specific examples of the present invention will now be described, by way of illustration only, with reference to the accompanying drawings, in which:

FIG. 1 is a schematic diagram illustrating the overall apparatus used in accordance with the present invention;

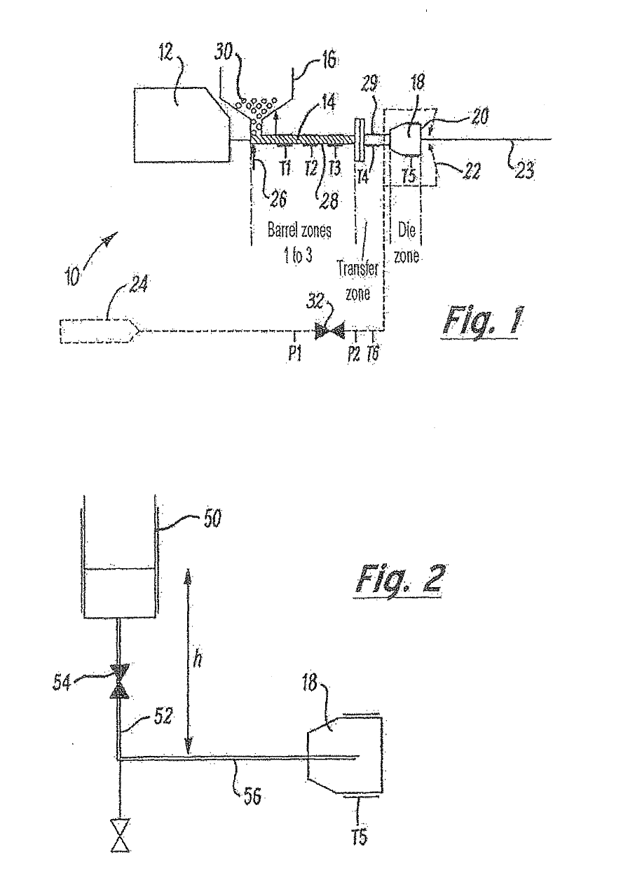

FIG. 2 is a schematic diagram illustrating the apparatus which can be used in conjunction with the apparatus shown in FIG. 1, so as to provide liquid filled tubules;

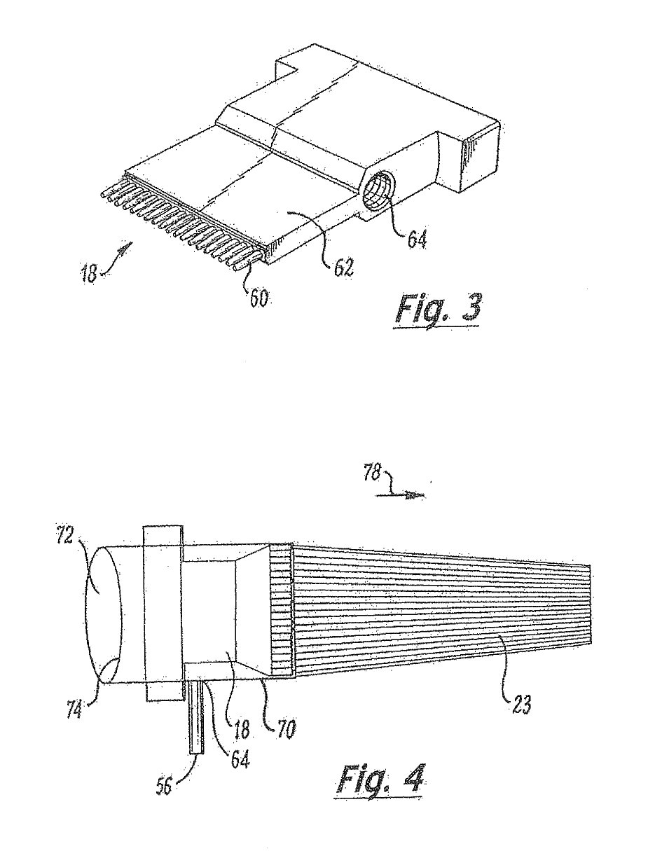

FIG. 3 is a perspective view of the extrusion die used to form tubules in the extruded material of the Example;

FIG. 4 is a plan view of the extrusion die which incorporates the extrusion die shown in FIG. 3 in the apparatus as illustrated in FIGS. 1 and 2;

FIG. 5 is a cross-sectional view of a confectionery product in accordance with the present invention, where four tubules have been extruded within the main body portion;

FIG. 6 is a cross-sectional view of a confectionery product in accordance with the present invention, where a number of tubules are located around the periphery of the body portion;

FIG. 7 is a cross-sectional view of a confectionery product in accordance with the present invention, where tubules are formed around the periphery of the body portion, but the material of the exterior of the tubules have been fused to one another;

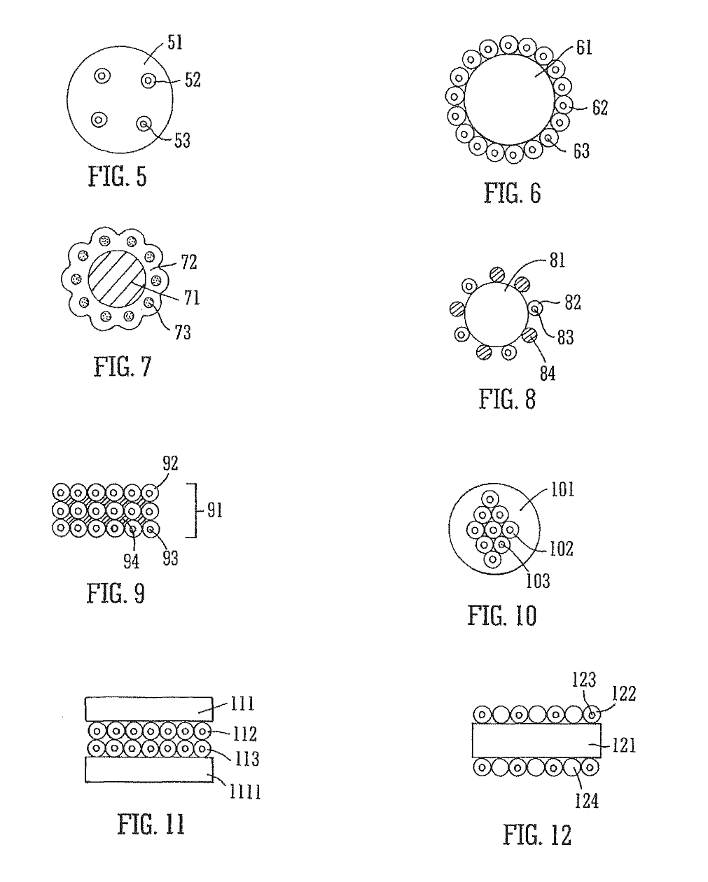

FIG. 8 is a cross-sectional view of a confectionery product in accordance with the present invention, where a number of tubules are located around the body portion and which are interspersed with rods of a different material;

FIG. 9 is a cross-sectional view of a confectionery product in accordance with the present invention, which is formed of a number of tubules which are held together by a body portion located within the gaps formed between adjacent tubules;

FIG. 10 shows a cross-sectional view of a confectionery product in accordance with the present invention, where a number of tubules have been extruded within close proximity to one another within the centre of the body portion;

FIG. 11 shows a cross-sectional view of a confectionery product in accordance with the present invention, where two layers of tubules are sandwiched between two body portion layers;

FIG. 12 shows a cross-sectional view of a confectionery product in accordance with the present invention, where a body portion layer is sandwiched between two separate layers of tubules.

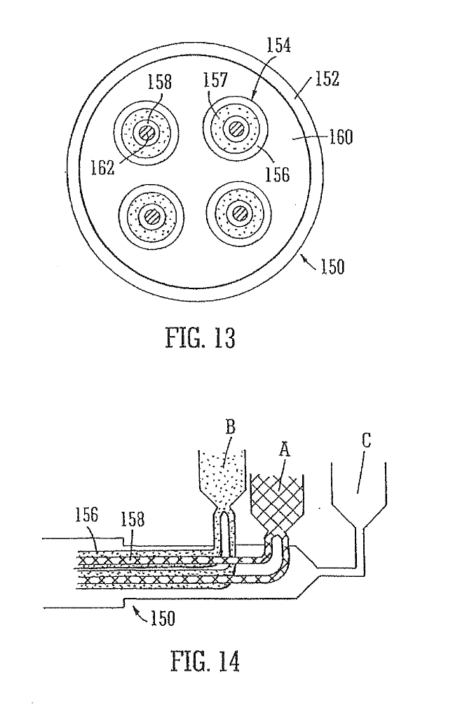

FIG. 13 is a cross-sectional view of a die head of an extruder used to manufacture the confectonery product shown in FIG. 5; and

FIG. 14 is a schematic diagram illustrating the supply of different materials to the die head shown in FIG. 13.

Experiments were conducted to produce a variety of consumable products incorporating tubules. Two phases of extrusion work were undertaken. The first phase concerned the extrusion of hard candy using a capillary die attached to a small-scale extruder in a non-food grade environment for creating candy extrudates containing chocolate tubes with air filled bores in both low- and high-voidage foams.

The second phase of the experimental work built upon the first phase to produce low and high voidage extrudates containing an array of tubules having chocolate tubes and cocoa butter bores. The first and second phases are described in the below Example.

Phase one concerned the extrusion of candy using a capillary die attached to a small-scale extruder, in order to confirm that candy having chocolate tubes could be formed in accordance with the present invention.

The materials that were trialled during this investigation are shown in Table 1.

TABLE 1
Materials tested.

| Material | | | |
|---|---|---|---|
| number | Material name | Majority ingredients | Application |
| 1 | Custom recipe 1 | Sugar (40%) Glucose | Extruded matrix |
| | | Syrup (60%) | |
| 2 | Chocolate | Milk chocolate | Tubule tube |
| 3 | Cocoa butter | Cocoa butter (100%) | Tubule bore |

Materials 1 and 2 were supplied as large solid blocks. All materials were crushed prior to extrusion to yield a fine granular powder, with grain sizes ranging between 1 mm and 5 mm. Material 3 was supplied as a tub of solidified cocoa butter; the required quantity was broken up into a fine powder containing only small lumps before being fed into the heated cocoa butter reservoir.

The extrusion equipment consisted of a Betol single screw extruder, with a screw diameter of approximately 12 mm, and a screw L/D ratio of roughly 22.5:1. The extruder had four different temperature zones (denoted T1-T4 in FIG. 1 as described later), each of which could be independently controlled using PID controllers connected to band heaters. The Mk 3 MCF extrusion die, containing an entrainment array consisting of 17 hypodermic needles, was connected on the extruder endplate. Two opposed air jets, used to rapidly quench the extrudate emerging from the extrusion die, were placed above and below the die exit; these jets were connected via a valve to a compressed air line at 6 Barg. A schematic diagram showing the general layout of the extrusion line is shown in FIG. 1 and a schematic drawing of the capillary die is shown in FIG. 2.

With reference to FIG. 1, there is shown a schematic diagram of the extrusion apparatus 10 used in the experiments. The apparatus briefly comprises an electric motor 12 which is rotatably coupled to an extrusion screw 14. The screw 14 is fed at one end by a hopper 16 and the opposing end is coupled to an extrusion die 18 having an extrudate outlet 20. Quench jets 22 are directed towards the die outlet 20 so as to cool the extruded material 23 which is produced and these jets are fed with compressed air 24. If desired, the area of the apparatus where the hopper 16 is coupled to the screw 14 can be cooled by means of a cooling feed 26. Surrounding the screw 14 is a barrel 28 which is formed having three barrel temperature zones denoted T1 to T3—the temperatures of each zone being capable of being controlled. The barrel 28 is connected to the die 18 by means of a feed conduit 29 which also has a temperature zone T4 which can be controlled.

In use, the hopper 16 is filled with material 30 (such as candy in solution) which can be heated so as to render it (or maintain it as) a liquid (not solid or solid particulate form). Before the material passes into the screw 14, it can be cooled by means of the cool feed 26, so as to ensure that the material is at the correct temperature for entering the screw extruder. As the screw is rotated, the liquid material is drawn along the screw 14, inside the barrel 28 and the temperature of the zones T1-T3 adjusted accordingly. The material then passes through the feed conduit 29 and the temperature is adjusted again (if required) by temperature control T4 before entering the die 18. The die 18 has a number of hollow needles with further hollow needles located concentrically inside them (not shown) located within an entrainment body so that the candy material passes over and around the outermost needles. Chocolate is extruded by a parallel similar extrusion process (not shown), and the chocolate passes though the void between the two concentric needles. At the same time that the candy and chocolate is being extruded, compressed air 24 is forced through the centre of the central hollow needles so that the chocolate contains hollow capillaries. The air can be pulsed on and off to make capillaries which actually comprise a line of discrete bubbles, or the air pressure can simply be altered to give rise to continuous capillaries having a varying cross-sectional area along their length, from having a relatively wide diameter (for example, almost as wide as the body portion of the product itself) to extremely narrow (for example, on the micrometer scale). Similar effects can be achieved by rotating the die(s) and/or the extrudate to ‘nip’ the capillaries and thus produce ‘bubbles’, and by adjusting the rate of flow of the extrudate. The extrudate 23 is cooled by means of the quench jets 22 as it is released from the die 18. A valve 32 controls the flow of compressed air to the apparatus and pressure devices P1 and P2 control the pressure of the compressed air 24 before and after the valve. The compressed air line also has a temperature control T6 so as to control the temperature of the air before entering the die.

With reference to FIG. 2, there is shown an adaptation of the apparatus shown in FIG. 1. Rather than compressed air 24 being forced through central compressed needles, these needles are connected to a reservoir 50 containing cocoa butter. The reservoir 50 is heated so that the cocoa butter is maintained at the correct temperature so as to maintain it in a liquid state. The reservoir 50 is connected to a conduit 52 having an isolation valve 54 for controlling the flow of liquid. The conduit 52 is encased in a trace heating tube 56 which maintains the temperature of the conduit so that the liquid remains in a liquid state during its movement within the conduit. The conduit 52 is coupled to the inlet to the die 18 having number of needles, so that when the material is being extruded, the capillaries formed around and the needles can be simultaneously filled with cocoa butter. Of course, the capillaries could be filled with other types of liquid material if desired. The rate of flow of cocoa butter is adjusted with time to give rise to varying cross-sectional areas of the capillaries with length. If a line of discrete bubbles is required, the flow of cocoa butter is pulsated on and off. Again similar effects can be achieved by rotating the die(s) and/or the extrudate to ‘nip’ the capillaries and produce bubbles, and by adjusting the rate of flow of the extrudate.

FIG. 3 shows a die 18 in more detail. In particular, this figure shows that the metallic die 18 has, at one end, a plurality of concentric needles 60 which are joined to a cavities 62 and 63 which are in fluid communication with an inlet channel 64 for pumping a fluid material such as cocoa butter into the bore of the tubule, and an inlet channel 65 for extruding chocolate into the tube of the tubule.

With reference to FIG. 4, there is shown the die 18 in place in an entrainment body 70. Molten material 72 enters an opening 74 of the entrainment body 70 and the material is forced over and around the concentric needles 60 of the die 18. At the same time, liquid cocoa butter and chocolate enters the die inlets by means of fluid feed conduits 56 and 57. When operational, the molten chocolate and cocoa butter are extruded through the entrainment body 70 over the concentric needles 60 of the die 18.

The apparatus described hereinabove can be adapted so as to produce an extruded body portion having tubules filled with a bore. A die head and process will be described later.

Examples of products made according to the present invention are shown in FIGS. 5-12.

In detail, FIG. 5 shows an extruded candy cylindrical body portion 51, with four equally spaced tubules comprising a chocolate tube 52 and a cocoa butter filled bore 53. This product provides an interesting taste profile for the consumer, as well as an interesting mouth sensation. Candy body portion 51, chocolate tube 52 and cocoa butter bore 53 are all extruded simultaneously, in accordance with the process described in FIGS. 1-4 and explained in greater detail later on.

FIG. 6 shows a gum body portion 61 surrounded by tubules comprising candy tubes 62 with caramel bores 63. The tubules are evenly spaced around the body portion 61, and each tubule touches another tubule. The tubules 62 were urged against the outer surface of the body portion 61 after extrusion. This arrangement provides a chewing gum with initial flavour impact of candy and caramel, and thus provides an interesting taste sensation to the consumer. The product is produced by modifying the apparatus of FIGS. 1-4 to site the concentric capillaries on the outside of the die for forming the body portion.

FIG. 7 shows a hard candy body portion 71 surrounded by tubules that have been merged together. These merged tubules specifically comprise merged tubes 72, and in this case the tubes are made of a soft candy. The bores 73 remain separate and are made of fruit puree. The merged tubes are extruded as separate tubes, and simply merge on contact due to their fluid nature on exit from the extrusion die.

FIG. 8 shows an arrangement similar to that of FIG. 6, but the tubules are not in contact with one another and instead are interspersed with other solid bores 84. In FIG. 8, the body portion 81 is made of a hard candy, and the solid bores 84 are made of soft candy. The tubules comprise a tube of chocolate 82 and a bore of cocoa butter 83.

FIG. 9 shows an embodiment wherein the body portion 91 is made up of an array of tubules. The tubules each comprise a soft candy tube 92 and a fruit puree bore 93. A body portion 94 of hard candy is located between the tubules. Each individual tubule can be broken away from the other tubules if desired, to provide a novel confectionery that can be consumed in stages.

FIG. 10 shows a body portion 101 made of dark chocolate. The tubules are arranged in a diamond pattern in the centre of the body portion, and comprise a tube of praline 102 and a bore 103 of white chocolate.

FIG. 11 shows an arrangement having two “slab-like” body portions 111 and 1111. These body portions can be the same or different, and preferably one comprises chocolate and the other comprises candy. Tubules are situated between the two body portions and attach them together, wherein the tubes 112 are made of hard caramel and the bores are made of cocoa butter.

FIG. 12 shows a body portion 121 made of chewing gum. This chewing gum body portion is flanked on its top and bottom surfaces with tubules comprising a tube 122 of hard candy and a bore 123 of flavoured liquid centre fill containing a cooling agent. In between each tubule there is a capillary 124 which is made of soft candy.

Referring now to FIG. 13, there is shown a die head 150 used to produce the confectionery product illustrated in FIG. 5. The die head 150 is formed with a circular lip 152, within which are located four co-axial nozzles 154. Each co-axial nozzle 154 consists of an outer flange 156 and an inner ring 158. In use, the body portion material will be pumped into the body cavity 160 which is formed between the circular lip 152 and the outer flange 156 of a nozzle 154. The material used to form the tubule will be pumped through the tubule cavity 157 formed between the outer flange 156 and the inner ring 158. Lastly, the bore material will be pumped through the bore cavity 162 inner ring 158.

FIG. 14 is a schematic illustration of the pumping arrangement required in order to supply the various materials to the die head shown in FIG. 13 in order to produce a confectionery product as illustrated in FIG. 5 and identical reference numerals have been used in order to identify identical features. Three hoppers A, B, C supply the die head 150 with the different components in order to form the confectionery product as shown in FIG. 5. In particular, hopper A feeds the bore cavity 162 with the “bore” material (cocoa butter), hopper B supplies the “tubule” material (chocolate) to the tubule cavity 157, and lastly, hopper C supplies the body” material (candy) to the body cavity 160. Supplies of the materials from hoppers A-C are closely controlled so as to ensure correct tubule/bore formation within the extruded body portion.

Although the body portion and tubules may be depicted as uniform in shape and pattern in some embodiments described herein, it should be understood that the body portion and/or the tubules may be non-uniform in some embodiments. There may be variations in the overall dimensions of the product, such as, for instance, the dimensions of the body portion, the capillaries, the wall thicknesses between each tubule and the outer wall thickness of the product. For example, in some embodiments, the mechanical process of extrusion and optional further manipulation of the extrudate, such as stretching, may create non-uniformities in the dimensions of the product. Such processes also may create random variations in the positioning of the tubules. The tubules accordingly may be irregularly positioned in some embodiments. In addition, the tubules may be symmetrically disposed in the body portion or asymmetrically disposed in the body portion. In some embodiments, one group of tubules may be symmetrically disposed and another group of tubules may be asymmetrically disposed in the body portion.

The foregoing embodiments are presented by way of example only, and it will be apparent to the skilled addressee that possible modifications and variations will readily present themselves to those skilled in the art.

1. A confectionery product comprising an extruded body portion and at least one extruded tubule, wherein the tubule comprises a tube of a first material and a bore of a second material, and the tube is formed of a different material than that of the body portion and/or the bore.

2. A confectionery product according to claim 1, wherein the tubules are positioned within the body portion.

3. A confectionery product according to claim 1, wherein the tubules are positioned on the outside of the body portion.

4. A confectionery product according to any preceding claim comprising more than one body portion.

5. A confectionery product according to any preceding claim comprising a plurality of tubules.

6. A confectionery product as claimed in any preceding claim, wherein the second material comprises a fluid material.

7. A confectionery product as claimed in claim 6, wherein the fluid material is a liquid or a liquid during extrusion.

8. A confectionery product as claimed in any preceding claim where the first material solidifies after extrusion.

9. A confectionery product as claimed in any preceding claim wherein the first material inhibits or prevents migration of the second material or a constituent of the second material into the body portion.

10. A method of manufacturing a confectionery product according to any preceding claim, the process comprising the steps of:
a) extruding a body portion, and
b) extruding a at least one tubule, wherein the tubule comprises a tube of a first material and a bore of a second material, and the tube is formed of a different material than that of the body portion and/or the bore.

11. A method according to claim 10, wherein steps a) and b) are sequential.

12. A method according to claim 10, wherein steps a) and b) are concurrent.

13. A method according to claim 10, wherein steps a) and b) are performed on the same machine.

14. A method according to any one of claims 10-13, wherein the at least one tubule is extruded within the body portion.

15. A method according to any one of claims 10-13, wherein the at least one tubule is extruded alongside to the body portion and the tubule is urged against the body portion so as to form a single confectionery product having two components.

16. A method according to any one of claims 10-15, wherein the method further comprises cutting and optionally coating the product.

17. An apparatus adapted for producing a confectionery product according to the process of claims 10-16.

18. A confectionery product substantially as described herein and with reference to the accompanying drawings.

19. A process for producing a confectionery product substantially as described herein and with reference to the accompanying drawings.
